(19) United States
(12) Patent Application Publication
(10) Pub. No.: US 2013/0178971 A1
(43) Pub. Date: Jul. 11, 2013

(54) SUBSTRATE PROCESSING APPARATUS AND POWER SOURCE MANAGEMENT METHOD

(71) Applicants: Koji Hashimoto, Kyoto (JP); Nobuhiro Mukuta, Kyoto (JP)

(72) Inventors: Koji Hashimoto, Kyoto (JP); Nobuhiro Mukuta, Kyoto (JP)

(21) Appl. No.: 13/822,916

(22) PCT Filed: Sep. 16, 2011
(86) PCT No.: PCT/JP2011/071243

§ 371 Date: Mar. 13, 2013

(30) Foreign Application Priority Data
Mar. 16, 2011 (JP) 2011-058263

(51) Int. Cl. G05B 19/02

(52) U.S. Cl. CPC G05B 19/02
USPC 700/121

(57) ABSTRACT

A substrate processing apparatus for processing a substrate comprising units for carrying out steps for processing the substrate; ON/OFF switching devices, corresponding to the respective units, switching between an ON state in which electric power is supplied to a corresponding unit and an OFF state in which supply of electric power for the unit is halted; and a control device for acquiring a production information including processing details and an end time limit for a substrate to be introduced into the substrate processing apparatus, preparing a time chart representing an operation scheme for the units based on the production information in a manner such that all of the steps carried out according to the processing details by the units are to be completed by the end time limit, and making the units operate according to the time chart while controlling the ON/OFF switching device according to the time chart.

### TECHNICAL FIELD

The present invention relates to a substrate processing apparatus for processing substrate and an electric power source management method of managing electric power supply therefor. Examples of substrates to be processed include semiconductor substrates, glass substrates for liquid crystal displays, glass substrates for plasma displays, substrates for FEDs (field emission displays), substrates for optical discs, substrates for magnet-optical discs, glass substrates for photomasks, substrates for ceramics, substrates for solar cells, etc.

### BACKGROUND ART

In manufacturing processes for semiconductor device, liquid crystal display device or the like, substrate processing apparatuses for processing substrates such as semiconductor wafer, glass substrate for liquid crystal display equipment, or the like are used. A substrate processing apparatus comprises a transfer unit for transferring a substrate, and a plurality of units including a processing unit for processing the substrate. Each of the units is connected to an electric power source, being driven by electric power supplied therefrom.

### CITATION LIST

### Patent Literature

PTL 1: JP-A-2003-289062

### SUMMARY OF INVENTION

### Technical Problem

However, with conventional substrate processing apparatus, each of the units is supplied with electric power (standby electric power), even during a period in which none of the units is performing steps for processing substrate such as transferring or chemical processing of a substrate.

Therefore, it is an object of the present invention to provide a substrate processing apparatus for decreasing consumption of electric power and a electric power source management method.

### Solution to Problem

The present invention provides substrate processing apparatus for processing wafers. The substrate processing apparatus comprises: a substrate processing apparatus for processing a substrate comprising: a plurality of units for carrying out steps for processing the substrate; a plurality of ON/OFF switching devices, corresponding to the respective units, switching between an ON state in which electric power is supplied to a corresponding unit and an OFF state in which supply of electric power for the unit is halted; and a control device for acquiring a production information including processing details and an end time limit for a substrate to be introduced into the substrate processing apparatus, preparing a time chart representing an operation scheme for the plurality of units based on the production information in a manner such that all of the steps carried out according to the processing details by the plurality of units are to be completed by the end time limit, and making the plurality of units operate according to the time chart while controlling the plurality of ON/OFF switching device according to the time chart.

According to this configuration, a control device acquires a production information including processing details and an end time limit. And then the control device prepares a time chart representing an operation scheme for the plurality of units based on the production information in a manner such that all of the steps carried out according to the processing details by the plurality of units is to be completed by the end time limit. The control device makes the plurality of units operate according to the time chart and also controls the plurality of ON/OFF switching device according to the time chart. Since the control device can identify a unit in standby condition (non-operating condition) or a unit that is to be in standby condition for a long period of time, for instance according to time chart, it is possible to systematically halt electric power supply for such units, thereby decreasing consumption of electric power. Also, by utilizing the production information, it is possible to prepare a time chart in a manner such that a plurality of units are optimally operated. Thus, it is also possible to decrease consumption of electric power through optimization of time chart. As is described, it is possible to decrease consumption of electric power effectively by preparing a time chart utilizing a production information and controlling electric power supply according to the time chart.

According to an embodiment of the present invention, the control device controls the plurality of ON/OFF switching device in a manner such that supply of electric power is halted for at least one of the plurality of the units during a non-operating period that is included in an executable period which spans from a time when the substrate is introduced into the substrate processing apparatus to the end time limit.

According to this configuration, the control device halts electric power supply for at least one of the plurality of the units during a non-operating period that is included in an executable period which spans from a time when the substrate is introduced into the substrate processing apparatus to the end time limit. Accordingly, since it is not required to supply electric power for each of the units during non-operating period, the control device halts electric power supply for at least one of the plurality of the units during a part or whole of the non-operating period, thereby decreasing consumption of electric power.

According to another embodiment of the present invention, the control device controls the plurality of ON/OFF switching devices in a manner such that supply of electric power is halted for at least one of the plurality of units in a non-operating condition during an operating period in which at least one of the plurality of units is operated according to the time chart.

According to this configuration, the control device halts electric power supply for at least one of the plurality of the units in a non-operating condition in which at least one of the plurality of units is operated according to the time chart. That is, since it is not required to supply electric power for a unit which is in a non-operative condition even during an operating period, the control device halts supply of electric power for a unit in a non-operating condition, thereby decreasing consumption of electric power.

The plurality of units preferably include a plurality of processing units. In this case, the control device preferably prepares a time chart in a manner such that a number of the processing units to be operated is minimized.

According to this configuration, the control device prepares a time chart in a manner such that a number of the processing units to be operated is minimized, and makes a plurality of units operate according to the time chart. In other words, the control device prepares a time chart in a manner such that a number of processing unit in a non-operating condition is maximized, and makes a plurality of units operate according to the time chart. Therefore, the control device is able to halt supply of electric power, even during an operating period, for a processing unit in a non-operating condition or an unit whose non-operating condition continues for a considerable period of time. With the time chart, because a number of processing units in a non-operation condition is at a maximum, it is possible to further decrease consumption of electric power.

According to still another embodiment of the present invention, the plurality of units includes a processing unit for processing the substrate and a chemical liquid supply unit for supplying chemical liquid to the processing unit. And the control device prepares the time chart in a manner such that a number of the plurality of chemical liquid supply units is minimized.

According to this configuration, the control device prepares a time chart in a manner such that a number of chemical liquid supply units to be operated is minimized, and makes a plurality of units operate according to the time chart. In other words, the control device prepares a time chart in a manner such that a number of chemical liquid supply units in a non-operation condition is maximized, and makes a plurality of units operate according to the time chart. Accordingly, the control device is capable of halting supply of electric power, even during operation period, for a chemical liquid supply unit by controlling a plurality of ON/OFF switching devices. It is possible to further decrease consumption of electric power because a number of chemical liquid supply units in a non-operation condition is at a maximum. Furthermore, as a number of chemical liquid supply units to be operated is few, the amount of chemical liquid to be prepared (for instance, by blending or adjusting temperature) accordingly becomes smaller. Thereby it is possible to decrease consumption of chemical liquid.

According to still another embodiment of the present invention, the plurality of units include a processing unit for processing the substrate and a chemical liquid supply unit for supplying chemical liquid for the processing unit, and the control device prepares the time chart in a manner such that a start time for the chemical liquid supply unit is scheduled at a time later than a time when the substrate is introduced into the substrate processing apparatus.

According to this configuration, the control device prepares a time chart in a manner such that a start time for the chemical liquid supply unit is scheduled at a time later than a time for introducing substrate into the substrate processing apparatus. The control device then makes a plurality of units operate according to the time chart. Accordingly it is possible to shorten a period between an end time at which every one of steps carried out by a plurality of units ends and an end time limit. It is possible to shorten a period during which chemical liquid life is wasted away, because chemical liquid is not supplied to a substrate during a period between an end time and an end time limit. In other words, by retarding a timing to start using chemical liquid, it is possible to attain essentially the same effect as that in prolonging the life of the chemical liquid. Thereby it is possible to decrease consumption of chemical liquid because chemical liquid is made to be used for more substrate processing.

According to still another embodiment of the present invention, the control device acquires the plurality of product information and prepares a time chart with which a plurality of substrates, corresponding to the plurality of production informations, are sequentially processed.

According to this configuration, the control device acquires a plurality of production informations and prepares a time chart in a manner such that a plurality of substrates corresponding to the plurality of production informations are sequentially processed. That is, the control device integrates a plurality of production informations and prepares a time chart based on the integrated production information. And then the control device makes a plurality of units operate according to the time chart. Thereby a plurality of substrates, corresponding to a plurality of production informations, are sequentially processed. Therefore, it is possible to shorten an operating period compared with a case in that a plurality of substrates are intermittently processed. In other words, it is possible to increase non-operating period. Therefore, it is possible to further decrease consumption of electric power.

According to still another embodiment of the present invention, the plurality of units include a plurality of processing units for processing substrates and the control device includes a counter for counting a number of substrate processings by each of the processing units and prepares a time chart in a manner such that each of the numbers of substrate processings by each of the processing units takes an averaged number.

According to this configuration, a number of substrate processing by each of the processing units is counted by a counter of the control device. The control device prepares a time chart in a manner such that respective numbers of substrate processing by each of the processing units take an averaged number. Therefore when maintenance parts which is to be exchanged according to respective number of substrate processing are provided in respective processing units, it is possible to have a number of usage such that each numbers of usage takes an averaged number. Because of this, the timings of exchange for a plurality of maintenance parts coincide or nearly coincide with each other, allowing simultaneous exchanges for a plurality of maintenance parts. Therefore it is possible to decrease a number of times to halt substrate processing apparatus in order to exchange maintenance parts, allowing for improvements on the productivity of substrate processing apparatus. Also, when it becomes necessary to exchange some the maintenance parts, it is possible to exchange them as well as the other maintenance parts while effectively using each of the maintenance parts because they are used on a averaged usage basis.

The substrate processing apparatus may further comprise a sensor, detecting malfunction of the substrate processing apparatus and being supplied of electric power on a steady basis.

According to this configuration, a sensor that detects malfunction of substrate processing apparatus is arranged in a substrate processing apparatus. The sensor is being supplied with electric power on a steady basis. Therefore it is possible to steadily detect malfunction of substrate processing apparatus. That is, it is possible to decrease consumption of electric power without sacrificing malfunction detecting performances.

The present invention further provides a power source management method for managing electric power supply for substrate processing apparatus. This method comprises: an acquiring step of acquiring a production information including processing details and en end time limit for a substrate; a preparing step of preparing a time chart representing an operation scheme for the plurality of units according to the production information in a manner such that all of the steps carried out according to the processing details by the plurality of units is to be completed by the end time limit; an making step of making the plurality of units operate by the control device according to the time chart; and a controlling step of controlling a plurality of ON/OFF switching devices, corresponding to the respective units, switching between an ON state in which electric power is supplied to a corresponding unit and an OFF state in which electric power is halted, according to the time chart.

The aforementioned and other objects, features, and effects of the present invention shall be clarified by the following description of the following preferred embodiments with references to the accompanying drawings.

### BRIEF DESCRIPTION OF DRAWINGS

FIG. 1 is a schematic diagram illustrating a substrate processing factory provided with a substrate processing apparatus according to an embodiment of the present invention.

FIG. 2 is a schematic diagram illustrating outline of a configuration example of a substrate processing apparatus according to an embodiment of the present invention.

FIG. 3 is a schematic diagram illustrating outline of a configuration example of a processing and chemical supply units provided in the substrate processing apparatus of FIG. 2.

FIG. 4 is a schematic diagram illustrating an electrical configuration of the substrate processing apparatus.

FIG. 5 is a graph showing an example of a time chart in a case that substrates are processed with eight processing units being operated in the substrate processing apparatus.

FIG. 6 is a graph showing an example of a time chart in a case that substrates are processed with four processing units being operated in the substrate processing apparatus.

FIG. 7 is a graph for illustrating the first to fourth time charts.

FIG. 8 is a graph for illustrating the fifth to seventh time charts.

FIG. 9 is a graph for illustrating a processing example in processing a plurality of lots by the substrate processing apparatus.

FIG. 10 is a graph for illustrating a processing example in processing a plurality of lots by the substrate processing apparatus.

### DESCRIPTION OF EMBODIMENTS

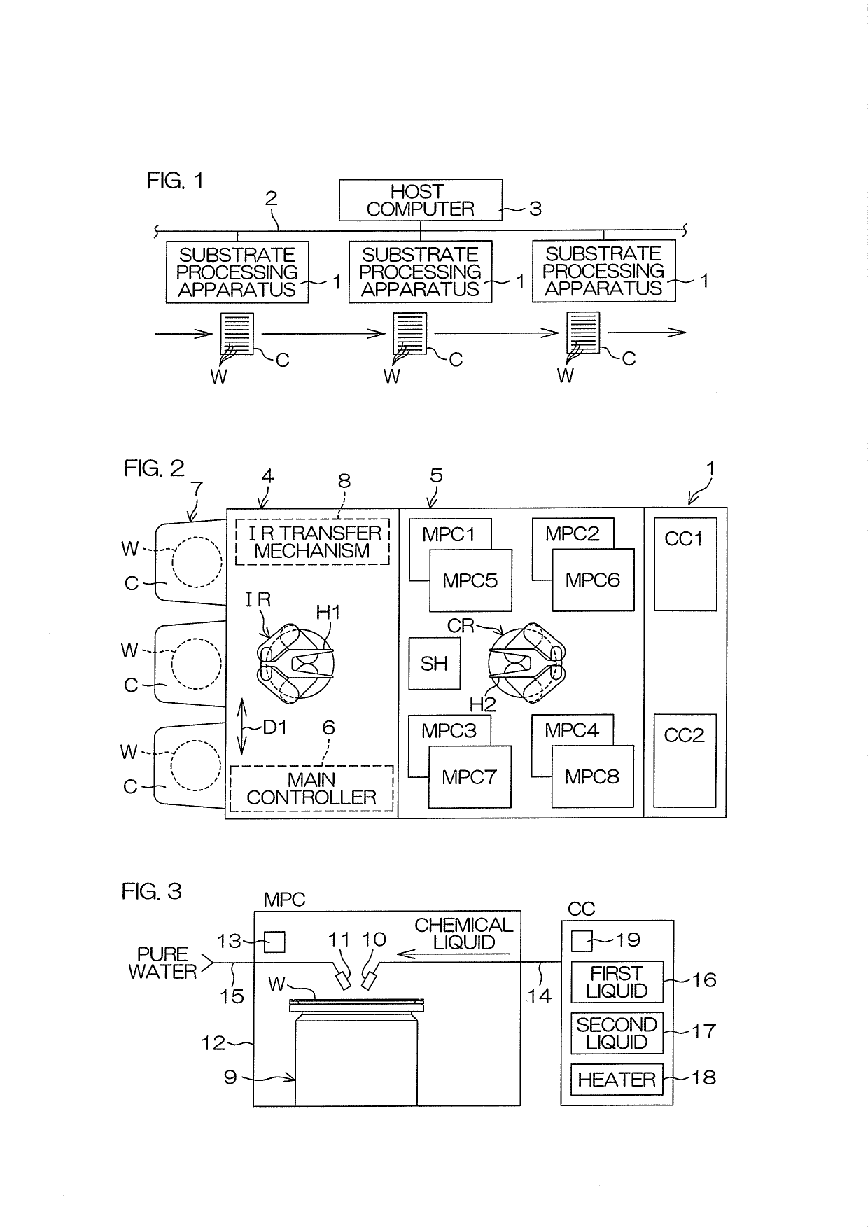

FIG. 1 is a schematic diagram illustrating a substrate processing factory provided with a substrate processing apparatus according to an embodiment of the present invention.

In a substrate processing factory, a plurality of substrate processing apparatus 1 is provided. The substrate processing apparatus 1 may be any one of a cleaning apparatus, heat processing apparatus, film forming apparatus, etching apparatus, resist coating apparatus, exposure apparatus, and developing apparatus, or may be an apparatus performing other process on a substrate. Also, the substrate processing apparatus 1 may be a batch-type apparatus that processes a plurality of substrates W in one lump, or a single wafer type apparatus that processes substrate W one by one. One or a plurality of substrates W, constituting one lot, are accommodated in a common carrier C which can accommodate, for instance, up to twenty-five sheets of substrate W. The carriers C are sequentially transferred to a plurality of substrate processing apparatuses 1. The substrate processing apparatus 1 is connected to a host computer 3 via network 2. The host computer 3 sends instructions to each substrate processing apparatuses 1 according to processing details set for individual lots. The substrate processing apparatus 1 processes a substrate W according to instructions from the host computer 3. With this, a sequence of processes is carried out on the substrate W by a plurality of substrate processing apparatuses 1.

FIG. 2 is a schematic diagram illustrating outline of a configuration example of a substrate processing apparatus according to an embodiment of the present invention. A case, wherein a substrate processing apparatus 1 is a single wafer type apparatus that processes substrate W one by one, will be explained hereinafter.

A substrate processing apparatus 1 comprises an indexer block 4, a processing block 5 for processing substrate W transferred into the indexer block 4, and a main controller 6 (control device) for controlling performances of devices provided in the substrate processing apparatus 1.

An indexer block 4 comprises a carrier holder 7, an indexer robot IR, and a IR transfer mechanism 8. The carrier holder 7 can hold a plurality of carriers C. A plurality of carriers C are held by the carrier holder 7, along a horizontal carrier aligning direction D1, in an aligned condition. The IR transfer mechanism 8 transfers the indexer robot IR in a carrier aligning direction D1. The indexer robot IR performs a transfer performance for transferring a substrate W into a carrier C held by the carrier holder 7, and a transfer performance for transferring the substrate W out of a carrier C. Furthermore, the indexer robot IR transfers a substrate W in an indexer block 4 as well as between the indexer block 4 and the processing block 5. The indexer robot IR is provided with a plurality of hands H1 each disposed at a different height. FIG. 2 shows a state of a pair of hands H1, one overlapping another.

Meanwhile, the processing block 5 comprises a plurality of (for example, eight) processing units MPC, a plurality of (for example, two) chemical liquid supply units CC for supplying chemical liquids to the processing unit MPC, a center robot CR transferring substrate W in the processing block 5, and a shuttle SH relaying substrate W between the indexer robot IR and the center robot CR. The eight processing units MPC are arranged, being paired such that one unit lapping over the another, surrounding the center robot CR in planar view. Shuttle SH is disposed on a side of the indexer block 4 rather than a center robot CR. The shuttle SH can hold a plurality of substrate W and transfers substrate W between the indexer robot IR and center robot CR. The indexer robot IR and center robot CR transfer a substrate W into the shuttle SH, and transfer a substrate W out of the shuttle SH. The center robot CR carries a substrate W between the shuttle SH and processing unit MPC. The center robot CR is provided with a plurality of hands H2 each disposed at a different height. In FIG. 2, it is shown that a pair of hands H2, one overlapping another.

FIG. 3 is a schematic diagram illustrating outline of a configuration example of processing and chemical supply units. In the descriptions hereinafter, one of numerals one to eight will be suffixed in order to distinguish eight processing units MPC. Likewise, one of numerals one to two will be suffixed in order to distinguish two chemical liquid supply units CC.

The processing unit MPC comprises: a spin chuck 9 horizontally holding and rotating the substrate W about the vertical axis passing through the center of the substrate W; a chemical liquid nozzle 10 ejecting chemical liquids toward a substrate W held by the spin chuck 9; a rinse liquid nozzle 11 ejecting rinse liquid toward the substrate W held by the spin chuck 9; a chamber 12 accommodating MPC components 9, 10 and 10; and a first sensor 13 (sensor) detecting malfunction of the processing unit MPC. The chemical liquid nozzle 10 is connected to a chemical liquid pipe 14. Chemical liquid from the chemical liquid supply unit CC is supplied to the chemical liquid nozzle 10 via the chemical liquid pipe 14. Also, the rinse nozzle 11 is connected to the rinse liquid pipe 15. Pure water (deionized water), an example of rinse liquid, is supplied to the rinse liquid nozzle 11 via the rinse liquid pipe 15. The first sensor may be, for example, a sensor for detecting leakage of liquid in the chamber 12, or a sensor for detecting leakage of electricity in the processing unit MPC.

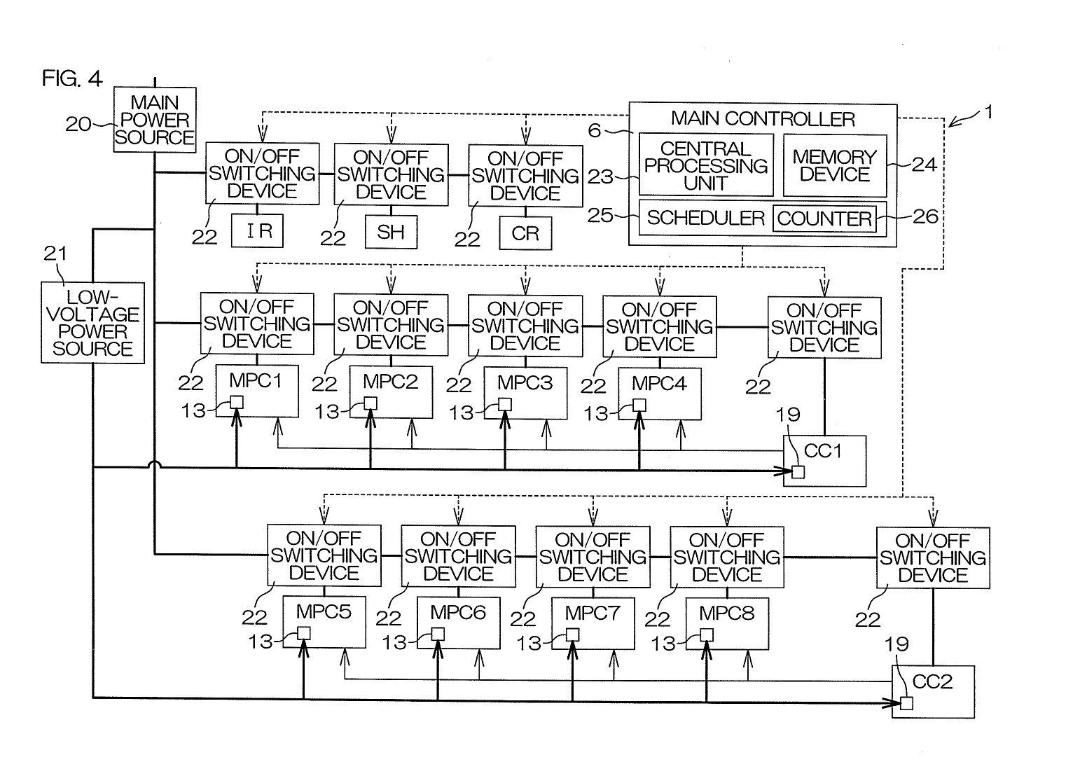

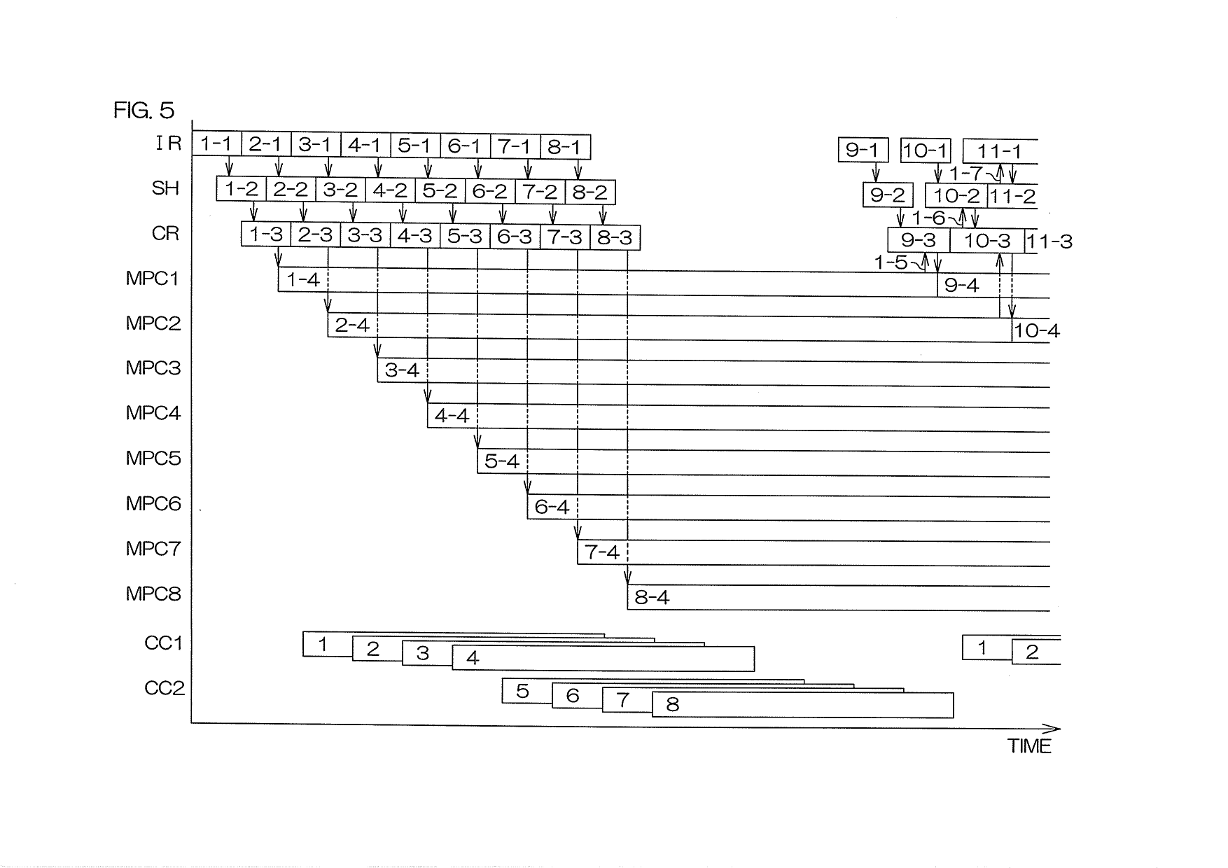

The chemical liquid supply unit CC comprises a first tank 16 reserving a first liquid, a second tank 17 reserving a second liquid, a heater 18 heating chemical liquids, and a second sensor (sensor) detecting malfunction of the chemical liquid supply unit CC. The second sensor 19 may be, for example, a sensor for detecting leakage of liquid in the chemical liquid supply unit CC, or a sensor for detecting leakage of electricity in the chemical liquid supply unit CC. The chemical liquid supply unit CC is configured to prepare a chemical liquid by mixing the first and second liquids. Temperature-adjusted chemical liquid is supplied to the chemical liquid nozzle 10. In the present embodiment, for example, four processing units MPC are connected to a common chemical liquid unit CC. As shown in FIG. 4, a chemical supply unit CC1 at one side supplies chemical liquids to four processing units MPC 1 to 4, and a chemical supply unit CC2 at another side supplies chemical liquids to four processing units MPC 5 to 8. Chemical liquids to be supplied to the chemical liquid nozzle 10 may be, for instance, any one of cleaning liquid, etching liquid, resist liquid, or developing liquid. As specific examples of chemical liquids, SC-1 (a compound liquid including NH₄OH and H₂O₂), BHF (a compound liquid including HF and NH₄F), or SPM (a compound liquid including H₂SO4 or H₂O₂) can be cited.

When a substrate W is processed, the main controller 6 controls the spin chuck 6 to rotate the substrate W by the spin chuck 9. And then the main controller 6 controls the chemical liquid nozzle 10 to discharge chemical liquids toward the rotating substrate W, thereby permitting chemical liquid supplied onto the substrate W (chemical liquid processing). Then the main controller controls to halt supply of chemical liquid toward the substrate W, and then controls to discharge pure water, that is an example of rinse liquids, from the rinse liquid nozzle 11 toward the substrate W. Thereby pure water is supplied onto the substrate W, washing out chemical liquid adhered thereto (rinse processing). And then after the supply of pure water toward the substrate W being halted, the main controller 6 makes the spin chuck 9 to rotate the substrate W in a high rotational velocity. Thereby pure water adhered to the substrate W is thrown off around the substrate W by centrifugal forces. As a result, the substrate W is dried by elimination of pure water therefrom (dry process). In this way, substrate W is processed by each of the units MPC.

FIG. 4 is a schematic diagram for explaining an electrical configuration of the substrate processing apparatus.

The substrate processing apparatus 1 further comprises: a main power source 20, distributing electric power supplied from electrical power source of substrate processing factory to a plurality of devices; a low-voltage power source 21, distributing electric power supplied from the main power source 20 to a plurality of devices; and a plurality of ON/OFF switching device 22, switching between an ON state in which electric power is supplied to a corresponding unit and an OFF state in which electric power is halted. The main power source 20 lowers electric power voltage supplied from the electric power source of the substrate processing factory to distribute the electric power, whose voltage being lowered, to the low-voltage power source 21, the ON/OFF switching devices, or the like. Likewise, the low-voltage power source 21 lowers electric power voltage supplied from the main power source 20 to distribute the electric power, whose voltage being lowered, to a first sensor 13 or a second sensor 19, or the like.

Indexer robot IR, shuttle SH, and center robot CR are transfer units for conducting substrate transfer step. Each of the transfer units is provided with an ON/OFF switching device 22. Furthermore, each of processing units MPC performing substrate processing steps is provided with an ON/OFF switching device 22 is provided. Likewise, Each of the chemical liquid supply units CC is provided with an ON/OFF switching device 22. That is to say, substrate transfer step, substrate processing step, and chemical liquid supply step are steps for processing substrate W. And each of the units IR, SH, CR, MPC, or CC for carrying out steps for processing substrate W is provided with an ON/OFF switching device. Hereinbelow, unit for carrying out steps for processing substrate W will be simply referred to as “unit U”.

By being controlled by the main controller 6, the ON/OFF switching device 22 switches between ON state and OFF state. Each of the unit U is supplied with electric power when corresponding ON/OFF switching device 22 is ON state. By contrast, the main controller 6 or each of the sensor 13 and 19 are supplied with electric power on a steady basis. The main controller 6 is connected to the host computer 3 (refer FIG. 1) via the network 2. The main controller 6 communicates with the host computer 3. When a carrier C is transferred to the substrate processing apparatus 1, a production information is transmitted to the main controller 6 from the host computer 3. The production information comprises processing details for substrate W that is to be introduced into the substrate processing apparatus 1, and end time limits for all of the steps for substrate W. According to the production information, the main controller 6 processes a substrate W introduced into the substrate processing apparatus 1.

More specifically, the main controller 6 comprises a CPU (central processing unit) 23, a memory device 24, and a scheduler 25, which functions through execution of programs stored in the memory device 24 by the CPU 23. The scheduler 25 includes a counter 26 that counts number of times of substrate processing by each of the processing unit MPC. The scheduler 25 prepares a time chart representing an operation scheme for the plurality of units based on a production information in a manner such that all of the steps that is to be carried out by the plurality of units according to the processing details included in the processing informations, is completed by the end time limit. And the main controller 6, by controlling a plurality of ON/OFF switching devices according to time chart, makes a plurality of unit U operate by supplying electric power thereto. With this, the substrate W introduced into the substrate processing apparatus 1 is processed according to the production information.

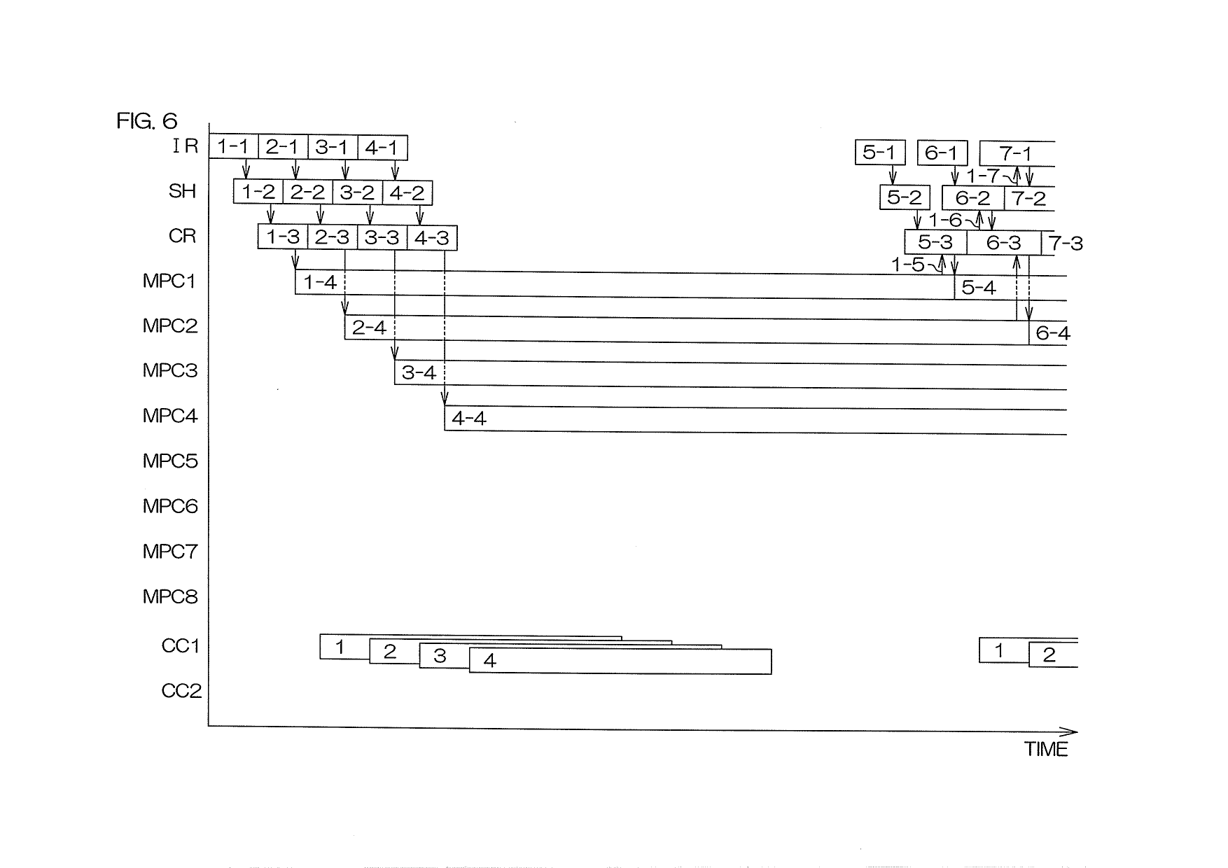

FIG. 5 is a graph showing an example of a time chart in a case that substrates W are processed by operating eight processing units. FIG. 6 is a graph showing an example of a time chart in a case that substrates are processed by operating four processing units.

The bars in FIGS. 5 and 6 extending in the horizontal direction represent corresponding units in operation. In addition, arrows shown in FIG. 5 and FIG. 6 represent transfer of substrate W. For example, the arrow extending from a bar shown as “1-1” to a bar shown as “1-2” represents a transfer of substrate W from indexer IR to shuttle SH.

Also, the numerals shown in FIGS. 5 and 6 (for example, “2-1”) at positions corresponding to the indexer robot IR, shuttle SH, center robot CR, and processing units MPC 1 to 8 (positions along longitudinal axis) represent somethingth step for somethingth substrate W. That is to say, “2” in “2-1” represents somethingth substrate W, while “1” in “2-1” represents somethingth step. Accordingly, “2-1” represents a first step (first step) to be performed for a second substrate W.

Also, the numerals shown in FIGS. 5 and 6 at positions corresponding to the chemical liquid supply units CC 1 to 2 represent which of the chemical liquid supply units CC supplies chemical liquids for which of the processing units MPC. For example, the numeral “1” shown at a position corresponding to the chemical liquid supply unit CC1 represents a state that chemical liquid is supplied from the chemical liquid supply unit CC1 for the processing unit MPC1.

A first step (step for “X-1”, X being arbitrary number) comprises a step ranging from a start of transfer of a carrier C by the indexer robot IR to a transfer of substrate W, being transferred out of the carrier C, into the shuttle SH.

A second step (step for “X-2”) comprises a step ranging from a start of displacement of shuttle SH toward the indexer robot IR to a time when the substrate W that is transferred into the shuttle SH by the indexer robot IR is transferred out by a center robot CR.

A third step (step for “X-3”) comprises a step ranging from a start of preparation for transferring the substrate W out of the shuttle SH by the center robot CR to a time when the substrate W being transferred out of the shuttle SH is transferred into the processing unit MPC.

A fourth step (step for “X-4”) comprises a step ranging from a time when the center robot CR transfers the substrate W into the processing unit MPC to a time when the substrate W, having been processed by the processing unit MPC, is transferred by the center robot CR.

Firstly, an example of time chart when twenty-five sheets of substrates W are processed by operating eight processing units MPC 1 to 8 will be explained.

As shown in FIG. 5, the main controller 6 makes the indexer robot IR, shuttle SH and center robot CR transfer the first substrate W from the carrier C into the processing unit MPC 1. (1-1, 1-2, 1-3) After completion of the transfer of the first substrate W by the indexer robot IR, the main controller 6 starts a transfer of a second substrate W by the indexer robot IR. (2-1) And then the main controller 6 makes the shuttle SH and center robot CR transfer the second substrate W from the shuttle SH to the MPC 2. (2-2, 2-3) The main controller 6, by making indexer robot IR, shuttle SH, and center robot CR repeatedly perform such procedures, transfers the first to eighth substrates into the respective processing units MPC 1 to 8. And then, after the eight substrates W are transferred into the MPC 1 to 8, the main controller 6 makes the indexer robot IR, shuttle SH, and center robot CR be on standby.

In the processing unit MPC 1 to 8, a chemical liquid processing, rinse processing, and dry processing are sequentially carried out. While chemical liquid processing is carried out in the processing units MPC 1 to 4, the main controller 6 makes the chemical liquid supply unit CC1 operate to supply chemical liquid from the chemical liquid supply unit CC1 to the processing units MPC 1 to 4. And then, after the completion of chemical liquid processing by the processing units MPC 1 to 4, the main controller 6 makes the chemical liquid supply unit CC1 be on standby. Likewise, while chemical liquid processing is carried out in the processing units MPC 5 to 8, the main controller 6 makes the chemical liquid supply unit CC2 operate to supply chemical liquid for processing units MPC 5 to 8. And then, after completion of chemical liquid processing in the processing units MPC 5 to 8, the main controller 6 makes the chemical liquid supply unit CC2 be on standby.

After completion of the processing of substrate W in the processing units MPC 1 to 8, the main controller 6 makes eight substrates W that are processed by the processing units MPC 1 to 8 be transferred sequentially from the processing units MPC 1 to 8 toward a carrier C. Specifically, the main controller 6 makes ninth substrate W be transferred from a carrier C to the center robot CR, in synchronism with a timing of completion of processing for the first substrate W in the processing unit MPC1. (9-1, 9-2) And then the main controller 6 makes the first substrate W be transferred out of the processing unit MPC 1 by a hand H2 of the center robot CR, which is not holding a substrate W. (1-5) Thereafter, the main controller 6 makes the ninth substrate W be transferred into the processing unit MPC 1, by introducing a hand H2 of the center robot CR that is holding the ninth substrate. (9-3) With this, the ninth substrate W, followed by the first substrate W, is processed in the processing unit MPC 1. (9-4) Likewise, the third step, being carried out for ninth substrate and thereafter in the time chart shown in FIG. 5, comprises a step for transferring a substrate W from the processing unit MPC by the center robot CR. (fifth step, or step for “X-5”)

Also, the main controller 6 makes a tenth substrate W be transferred to the shuttle SH from carrier C, in synchronization with a timing of completion of processing for the second substrate W in the processing unit MPC 2. (10-1) When the tenth substrate W is transferred into the shuttle SH, the center robot CR holds the first substrate W. The main controller 6 makes the first substrate W be transferred into the shuttle SH by the center robot CR. (1-6) Thereafter, the main controller 6 makes the tenth substrate W be transferred out of the shuttle SH by the center robot CR. (10-2) And then the main controller 6 makes the tenth substrate W be transferred into the processing unit MPC 2 by the center robot CR. (10-3) As described, the second step, which is carried out for the tenth substrate W and thereafter in the time chart shown in FIG. 5, comprises a step for transferring substrate W into the shuttle SH by the center robot CR. (sixth step, or step for “X-6”)

Also, the main controller 6 makes a eleventh substrate W be transferred out of carrier C by the indexer robot IR, in synchronization with the completion of processing for a third substrate W in the processing unit MPC 3. At a time when the indexer robot IR transfers the eleventh substrate W out of carrier C, the shuttle SH is holding the first substrate W. The main controller 6 makes the first substrate W be transferred out of the shuttle SH by the hand H1 of indexer robot IR, which is not holding a substrate W. Thereafter, the main controller 6 makes the eleventh substrate W be transferred into the shuttle SH by the hand H1 of indexer robot IR, which is holding a substrate W. (11-1) And then the main controller 6 makes the eleventh substrate W be transferred into the processing unit MPC 3 from the shuttle SH by the shuttle SH and center robot CR. (11-2, 11-3) Also, the main controller 6 makes the first substrate W, held by the indexer robot IR, be transferred into carrier C by the indexer robot IR. As is described, the first step, which is carried out for eleventh substrate W and thereafter in the time chart shown in FIG. 5, comprises a step for transferring a substrate W out of the shuttle SH by the indexer robot IR. (seventh step, or step for “X-7”).

The main controller 6 makes each unit U repeatedly carry out procedures as is described above. That is to say, for ninth substrate W and thereafter, the main controller 6, concurrently with the transfer of substrate W to the processing unit MPC 1 to 8, makes the indexer robot IR, shuttle SH, and center robot CR carry out the transfer of the substrate W toward a carrier C. Then, as for the last string of eight substrates W (from eighteenth to twenty-fifth substrates W), which are processed by the processing unit MPC 1 to 8, the main controller 6 makes the indexer robot IR, shuttle SH, and center robot CR carry out only transfer procedure to transfer the substrates into the carrier C. As is described, in the time chart shown in FIG. 5, twenty-five substrates W are processed by repeating a cycle from a process for substrate W in the processing unit MPC 1, to a process for substrate W in the processing unit MPC 8.

Next, an example of time chart when twenty-five sheets substrates W are processed by activating four processing units MPC 1 to 4 will be explained. Specifically, an example of time chart is shown wherein twenty sheets of substrates W are processed by only four processing units MPC 1 to 4, without operating four processing units MPC 5 to 8.

As is shown in FIG. 6, the main controller 6 makes the indexer robot IR, shuttle SH, and center robot CR transfer a first substrate W from carrier C into the processing unit MPC 1. (1-1, 1-2, 1-3) After completing transfer of the first substrate W by the indexer robot IR, the main controller 6 starts transfer of the second substrate W by the indexer robot IR. (2-1) And then, the main controller 6 makes the shuttle SH and center robot CR transfer the second substrate W from the shuttle SH to the processing unit MPC2. (2-2, 2-3) The main controller 6 makes the indexer robot IR, shuttle SH, and center robot CR repetitiously carry out procedures such as these to transfer the first to fourth substrates W into the processing units MPC 1 to 4. And then, after the four substrates W are transferred into the processing units MPC 1 to 4, the main controller 6 makes the indexer robot IR, shuttle SH, and center robot CR be on standby.

Chemical liquid processing, rinse processing, and dry processing are sequentially carried out in the processing units MPC 1 to 4. (1-4, 2-4, 3-4, 4-4) While chemical liquid processing being carried out in the processing units MPC 1 to 4, the main controller 6 makes the chemical liquid unit CC1 operate to supply chemical liquid therefrom for the processing units MPC 1 to 4. And then, after completion of the chemical liquid processing in the processing units MPC 1 to 4, the main controller 6 makes the chemical liquid supply unit CC1 be on standby. Meanwhile, the main controller 6 makes the chemical liquid supply unit CC2 be on standby because the processing units MPC 5 to 8 are in a non-operating condition. In other words, the chemical liquid supply unit CC2 is in a non-operating condition.

After the completion of processing of substrate W in the processing units MPC 1 to 4, the main controller 6 makes the four substrates W be sequentially transferred from the processing units MPC 1 to 4 into a carrier C. Specifically, the main controller 6 makes the center robot CR transfer a fifth substrate W, in synchronization with the timing when processing for the first substrate W in the processing unit MPC 1 is finished, from the carrier C toward the center robot CR. (5-1, 5-2) And then, the main controller 6 makes the first substrate W be transferred out of the processing unit MPC1 by a hand H2 of the center robot CR, which is not holding a substrate W. (1-5) Thereafter, the main controller 6 makes the ninth substrate W be transferred into the processing unit MPC 1, by introducing a hand H2 of the center robot CR that is holding the fifth substrate (5-3). With this, the fifth substrate W, followed by the first substrate W, is processed in the processing unit MPC 1. (5-4) Likewise, the third step, being carried out for fifth substrate and thereafter in the time chart shown in FIG. 6, comprises a step for transferring a substrate W from the processing unit MPC by the center robot CR. (fifth step, or step for “X-5”)

Also, the main controller 6 makes a sixth substrate W be transferred to the shuttle SH from carrier C, in synchronization with a timing of completion of processing for a second substrate W in the processing unit MPC 2. (6-1) When the sixth substrate W is transferred into the shuttle SH, the center robot CR is holding the first substrate W. The main controller 6 makes the first substrate W be transferred into the shuttle SH by the center robot CR. (1-6) Thereafter, the main controller 6 makes the sixth substrate W be transferred out of the shuttle SH by the center robot CR. (6-2) And then the main controller 6 makes the sixth substrate W be transferred into the processing unit MPC 2 by the center robot CR. (6-3) As described, the second step, which is carried out for the sixth substrate W and thereafter in the time chart shown in FIG. 6, comprises a step for transferring substrate W into the shuttle SH by the center robot CR. (sixth step, or step for “X-6”)

Also, the main controller 6 makes a seventh substrate W be transferred out of carrier C by the indexer robot IR, in synchronization with the completion of processing for a third substrate W in the processing unit MPC 3. At a time when the indexer robot IR transfers the seventh substrate W out of carrier C, The shuttle SH is holding the first substrate W. The main controller 6 makes the first substrate W be transferred out of the shuttle SH by the hand H1 of indexer robot IR, which is not holding a substrate W. (1-7) Thereafter, the main controller 6 makes the seventh substrate W be transferred into the shuttle SH by the hand H1 of indexer robot IR, which is holding a substrate W. (7-1) And then the main controller 6 makes the seventh substrate W be transferred into the processing unit MPC 3 from the shuttle SH by the shuttle SH and center robot CR. (7-2, 7-3) Also, the main controller 6 makes the first substrate W, held by the indexer robot IR, be transferred into carrier C by the indexer robot IR. As is described, the first step, which is carried out for the seventh substrate W and thereafter in the time chart shown in FIG. 6, comprises a step for transferring a substrate W out of the shuttle SH by the indexer robot IR. (seventh step, or step for “X-7”)

The main controller 6 makes each unit U repeatedly carry out procedures as is described above. That is to say, as for a fifth substrate W and thereafter, the main controller 6, concurrently with the transfer of substrate W to the processing unit MPC 1 to 4, makes the indexer robot IR, shuttle SH, and center robot CR carry out the transfer of the substrate W to a carrier C. Then, as for the last string of four substrates W (from twenty-second to twenty-fifth substrates W), which are processed by the processing units MPC 1 to 4, the main controller 6 makes the indexer robot IR, shuttle SH, and center robot CR carry out to only transfer the substrates into the carrier C. As is described, in the second time chart, twenty-five substrates W are processed by repeating a cycle from a process for substrate W in the processing unit MPC 1, to a process for substrate W in the processing unit MPC 4.

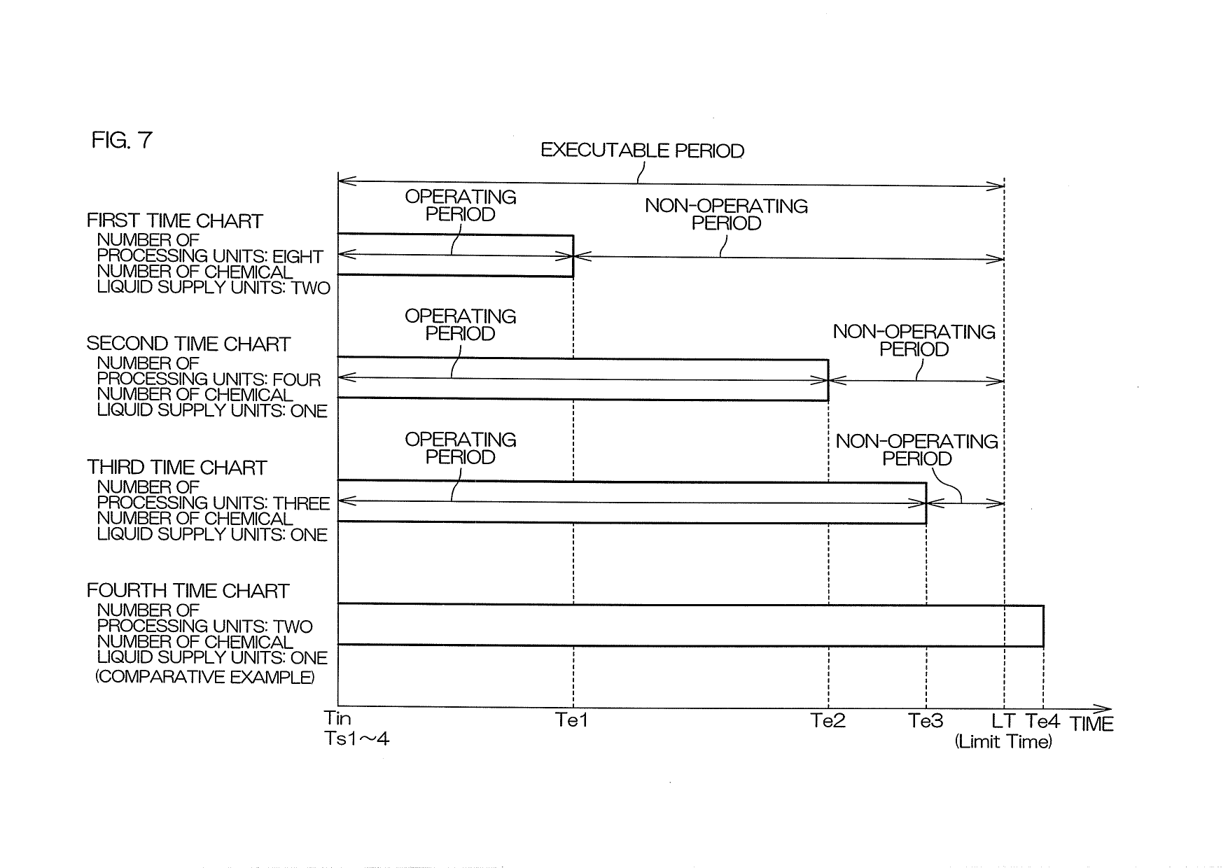

FIG. 7 is a graph for illustrating the first to fourth time charts. The first to third time charts represent an embodiment example for the present invention and the fourth time chart represents a comparative example.

Each of the first to fourth time charts is a time chart for processing twenty substrates W. Differences between the first to fourth time charts are number of processing units MPC to be operated and number of chemical liquid supply units to be operated.

Specifically, in the first time chart, substrate W is processed by eight processing units MPC; while in the second time chart, substrate W is processed by four processing units MPC. Also, in the third time chart, substrate W is processed by three processing units MPC; while in the fourth time chart, substrate W is processed by two processing units MPC. Also, in the first time chart, two chemical liquid supply units CC are operated; while in the second to four time chart, one chemical liquid supply units CC are operated.

Each unit U in the first time chart acts in a manner as is explained referring FIG. 5, and each unit U in the second time chart acts in a manner as is explained referring FIG. 6. Also, each units in the third and fourth time charts acts in the same manner as in the second time chart. Specifically, in the third time chart, an single cycle, which spans from a time when a substrate W is processed in the processing unit MPC1 to a time when the substrate W is processed in the unit MPC 3, is repeated. Also, in the third time chart, an single cycle, which spans from a time when a substrate W is processed in the processing unit MP1 to a time when the substrate W is processed in the unit MPC2, is repeated.

As is shown in FIG. 7, in the first to fourth time charts, a plurality of units U are started from the time when substrate W is introduced (Tin). That is, in the first to fourth time charts, Ts1 to Ts4, which are timings when at least action of one of the units U is started, coincide with Tin, which is a timing when substrate W is introduced. Also, end times Te1 to Te4, at each of which all steps carried out by the plurality of units U ends, are chronologically in order of first, second, third, and fourth time charts. In addition, end times Te1 to Te3 for the first to third time charts are arranged at an earlier time than the end time LT, while end time Te4 for the fourth time chart is arranged at an later time than the end time LT. Accordingly, in the first to third time charts, all steps carried out by the plurality of units U are completed before the end time limit LT.

Also, in each of the first to third time charts, there is a non-operating period, in which none of the plurality of units U is operated, during an executable period; because a length of operating period during which at least one of the plurality of units U is operated is shorter than a length of executable period, which spans from an introducing time Ti to an end limit time LT. The main controller 6 halts supply of electric power for at least one of the plurality of units U during a part or whole of the non-operating period, by controlling a plurality of ON/OFF switching devices 22.

Moreover, the main controller 6 halts supply of electric power to a unit U that is in a non-operating condition during an operating period, by controlling a plurality of ON/OFF switching device 22. Specifically, as is shown in FIG. 5, the main controller 6 makes the indexer robot IR be on standby without operating thereof, during from a time when the first step for an eighth substrate W (8-1) is completed to a time when the first step for a ninth substrate W (9-1) is started. Likewise for the shuttle SH, center robot CR, processing unit MPC 1 to 8, and chemical liquid supply units CC 1 to 2, each of them has a corresponding period in which those devices are kept on standby during the first time chart is executed (operating period). A unit U that is on standby is in a non-operating condition. When non-operating condition is continued for longer than a given time, the main controller 6 halts, even during the time chart is being executed, supply of electric power for at least one unit U that is in a non-operating condition, by controlling an ON/OFF switching device 22 which corresponding to a unit U in non-operating condition.

Also, as shown in FIG. 6, in the second time chart, the processing units MPC 5 to 8 and the chemical liquid supply unit CC2 are not operated. That is, the processing units MPC 5 to 8 and the chemical liquid supply unit CC2 are in a non-operating condition during a period when the second time chart is executed (operating period); accordingly during a part of whole of the period, the main controller 6 halts supply of electric power to the processing units MPC 5 to 8 and the chemical liquid supply unit CC2 even during a period when the second time chart is being executed. Thereby, consumption of electric power for the substrate processing apparatus as a whole is decreased, owning to for example, decrease of consumption of electric power by heater 18 for the chemical liquid supply unit CC2.

Likewise, in the third time chart, the processing units MPC 4 to 8 and chemical liquid supply unit CC2 are not operated; thus the processing units MPC 4 to 8 and chemical liquid supply unit CC2 are in a non-operating condition during the third time chart is executed; accordingly the main controller 6 halts supply of electric power to the processing units MPC 4 to 8 and chemical liquid supply unit CC2 during a part or whole of the period, even during a period when the third time chart is executed. Thereby consumption of electric power for the substrate processing apparatus as a whole is decreased.

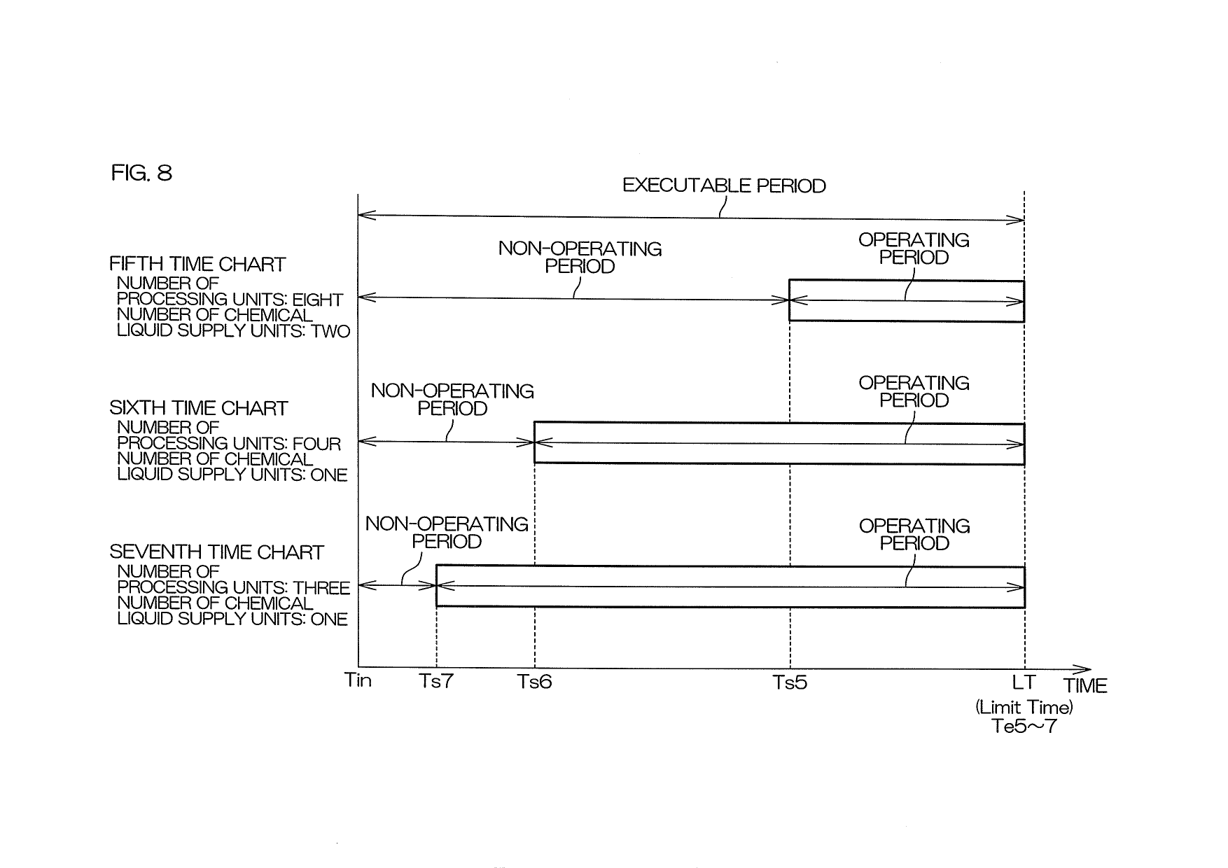

FIG. 8 is a graph for illustrating a fifth to seventh time charts.

The fifth to seventh time charts correspond to the first to third time charts in like manners, respectively. Specifically, as is evident from the comparison between FIG. 7 and FIG. 8, the only difference between the first and fifth time charts is the start times Ts1 and Ts5, whereas units to be operated and actions for each unit U to be engaged are the same. Likewise, the only difference between the second time chart and the sixth time chart is the start time Ts2 and Ts6, whereas units to be operated and actions to be engaged are the same. Likewise, the only difference between the third time chart and the seventh time chart is the start time Ts3 and Ts7, whereas units to be operated and actions to be engaged are the same.

In the fifth to seventh time charts, in like manners as in the first to third time charts, supply of electric power for at least a unit is halted during a part or whole of non-operating period. Also in the fifth to seventh time chart, supply of electric power for a unit U that is not in operation during operating period, or in a non-operating condition, is halted in like manners as in the first to third time charts.

As shown in FIG. 8, in the fifth to seventh time charts, actions for a plurality of units U are started in a manner such that end times Te5 to Te7 coincide with the end time limit LT. That is, in the fifth to seventh time charts, start times Ts5 to Ts7 are set at later than the time Ts, which is a time when substrate W is to be entered into the substrate processing apparatus 1. As already described, the chemical liquid supply unit CC prepares a chemical liquid by mixing a first and second liquids, for instance. There are cases that the chemical liquid prepared by mixing of a first and second liquid has a given lifetime that starts from the mixing. When newly preparing a chemical liquid, in the first to third time charts, it is required that mixing of a first and second liquid is started before introducing a substrate W into the substrate processing apparatus or at a time in the early stage of an executable period. And as shown in FIG. 7, in the first to third time charts, chemical liquids are not used during from end times Te1 to Te3 to end time limit LT, thereby lifetimes of chemical liquids being wasted away during that time.

By contrast, as shown in FIG. 8, in the fifth to seventh time charts, end times Te5 to Te7 coincide with time limit LT, thereby lifetimes of chemical liquids not being wasted away during from end times Te5 to Te7 to end time limit LT. Also, in the fifth to seventh time charts, a time to start mixing a first and second liquids is set at later than those in the first to third time charts, thus preventing lifetimes of chemical liquids from being wasted away during introducing time Tin and start times Ts5 to Ts7. Thereby, it is possible to efficiently use chemical liquids.

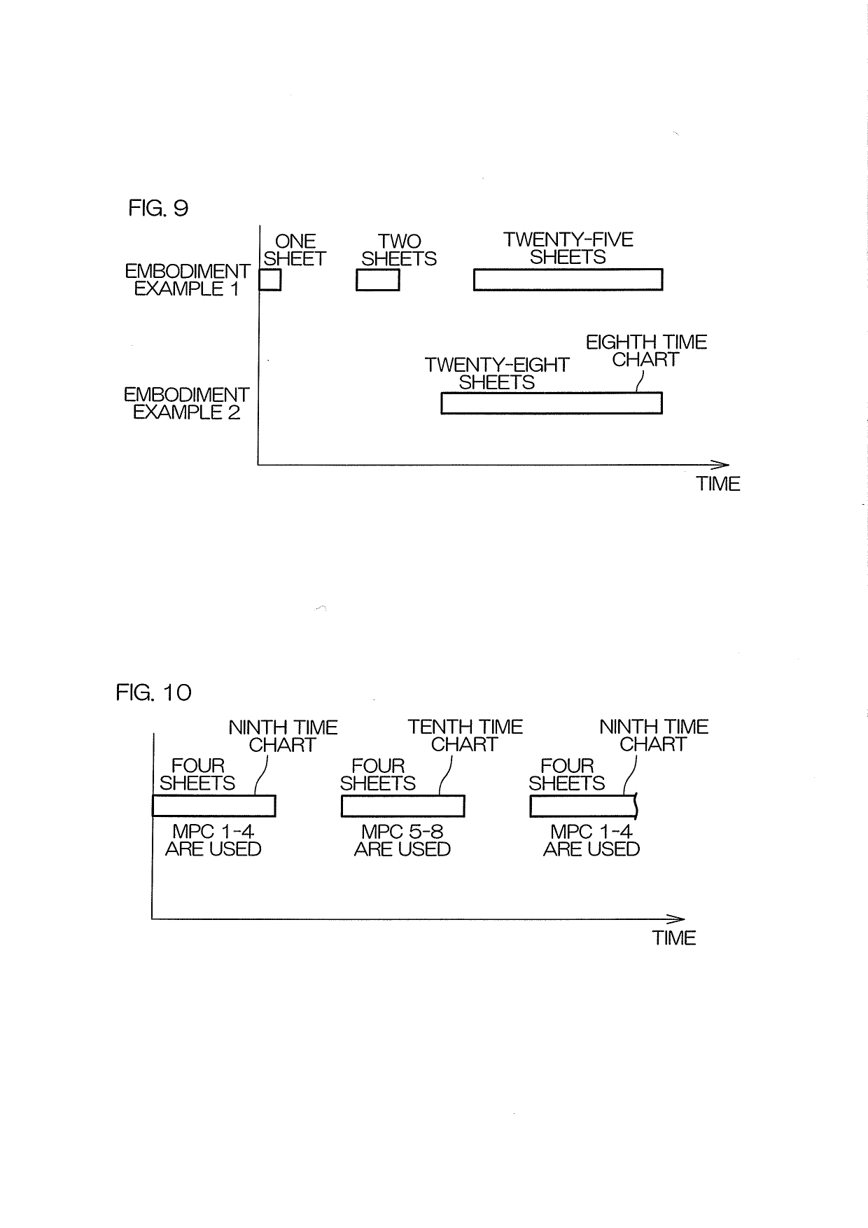

FIG. 9 is a graph for illustrating a processing example in processing a plurality of lots by the substrate processing apparatus.

When a plurality of carriers C are sequentially transferred to the substrate processing apparatus 1, a plurality of production informations each corresponding to a plurality of respective carries C are sequentially transmitted. The main controller 6 acquires the plurality of production informations to prepare a plurality of time charts each corresponding thereto. And then, the main controller 6 makes a plurality of units U operate according to the plurality of time charts. Thereby plurality of lots are sequentially processed. Specifically, when a carrier C loaded with one substrate W, a carrier C loaded with two substrates W, and a carrier C loaded with twenty-five substrates W are sequentially transferred to the substrate processing apparatus 1, a substrate W in the first lot is processed as shown in an embodiment example 1 in FIG. 9. Thereafter, two substrates W in the next lot are sequentially processed. And then, twenty-five substrates W in the last lot are sequentially processed.

Meanwhile, when a plurality of production informations are transmitted from the host computer 3, the main controller 6 acquires the plurality of production informations to integrate the production informations. And then, the main controller 6 prepares a time chart based on the integrated production informations. Specifically, when a carrier C loaded with one substrate W, a carrier C loaded with two substrates W, and a carrier C loaded with twenty-five substrates W are sequentially transferred to the substrate processing apparatus 1, the main controller 6 prepares a time chart (the eighth time chart) by which twenty-eight substrates W are sequentially processed. And then, the main controller 6 makes a plurality of units U operate according to the time chart. With this, twenty-eight substrates W are sequentially processed.

FIG. 10 is a graph for illustrating a processing example in processing a plurality of lots by the substrate processing apparatus.

As is described, the main controller 6 includes a counter 26 for counting a number of substrate processing by each of the processing units MPC. The main controller 6 prepares a time chart in a manner such that the numbers of substrate processing by each of the processing units are averaged. That is for example, when carriers C loaded with four substrates W are sequentially transferred to the substrate apparatus 1, the main controller 6 prepares a time chart for the first lot (the ninth time chart), for processing four substrates W by processing units MPC 1 to 4, and makes a plurality of units U operate according to the time chart. And then, the main controller 6 prepares a time chart for the next lot (the tenth time chart), for processing four substrates W by processing units MPC 5 to 8, and makes a plurality of units U operate according to the time chart. The main controller 6 prepares a time chart for the further next lot (the ninth time chart), for processing four substrates W by processing units MPC 1 to 4, and makes a plurality of units U operate according to the time chart. As in a manner as described above, the main controller 6 makes a plurality of units U operate such that processing of substrates W by the processing units MPC 1 to 4 alternate those by the processing units MPC 5 to 8. Thereby, the each number of substrate processing by each processing units is averaged.

As described hereinabove, in the present embodiment, the main controller 6 acquires processing details for substrate W which is to be introduced into the substrate processing apparatus 1 and production information including end time limit LT. And then, the main controller 6 prepares a time chart representing an operation scheme for a plurality of units based on the production information in a manner such that all of the steps carried out according to the processing details by the plurality of units is to be completed by the end time limit. The main controller 6 makes a plurality of units U operate according to the time chart, and controls a plurality of ON/OFF switching devices 22 according to the time chart. Since the main controller 6 can, for instance, identify, according to time chart, an unit U being on standby (in a non-operating condition) or an unit U that is to be in a standby condition for a long time, it is possible to systematically halt supply of electric power to these units U, thereby decreasing consumption of electric power. Also, because it is possible to prepare time chart in a manner such that a plurality of units U optimally operate by utilizing production information, it is possible to decrease consumption of electric power through optimization of a time chart. As in this manner, it is possible to effectively decrease consumption of electric power for the substrate processing apparatus 1 by preparing time chart utilizing production information and controlling supply of electric power for each of the units U according to the time chart.

Also in the present embodiment, the main controller 6 halts electric power supply for at least one of the plurality of the units U during a non-operating period in which none of the plurality of units U is not operated according to the time chart, in an executable period which spans from a time Tin when substrate W is introduced to an end time limit LT. That is, because electric power supply to units U is not required during non-operating period, the main controller 6 halts electric power supply for at least one of a plurality of units U during a part or whole of non-operating period, thereby decreasing consumption of electric power.

Also in the present embodiment, the main controller 6 halts electric power supply for at least one unit U in a non-operating condition during executable period in which at least one of the plurality of units U is operated according to the time chart. That is, because supply of electric power for unit U in non-operating condition is not required even during operating period, the main controller 6 halts supply of electric power for a unit U in non-operating condition; thereby decreasing consumption of electric power.

Also, according to the present embodiment, the main controller 6 prepares a time chart in a manner such that a number of the processing units MPC (the third and seventh time chart) to be operated is minimized and makes a plurality of units U operate according to the time chart. In other words, the main controller 6 prepares a time chart in a manner such that a number of the processing units MPC in non-operating condition is maximized, and makes a plurality of units U operate according to the time chart. Thus, the main controller 6 can halt supply of electric power, even during operating period, for a processing unit MPC in a non-operating condition or an unit U whose non-operating condition continues for a long time. With this time chart, because the number of processing units MPC in non-operating condition is at a maximum, it is possible to further decrease consumption amount of electric power.

Also according to the present embodiment, the main controller 6 prepares a time chart in a manner such that a number of the chemical liquid supply units CC to be operated (the second, third, sixth, and seventh time charts) is minimized, and makes a plurality of units U operate according to the time chart. In other words, the main controller 6 prepares a time chart in a manner such that a number of chemical liquid supply units CC in non-operating condition is maximized, and makes a plurality of units U operate according to the time chart. Thus the main controller 6 can halt supply of electric power for chemical liquid supply unit CC in a non-operating condition by controlling a plurality of ON/OFF switching devices 22, even during operating period. With the time chart, because the number of chemical liquid supply units CC in non-operating condition is at a maximum, it is possible to further decrease consumption of electric power. Moreover, because the number of chemical liquid supply units CC to be operated is few, amount of chemical liquid to be prepared (mixing, temperature control or the like) in the substrate processing apparatus 1 accordingly become smaller. Thereby it is possible to decrease consumption of chemical liquid.

Also, according to the present embodiment, the main controller 6 prepares a time chart (the fifth to seventh time charts) in a manner such that a start time for the chemical liquid supply unit is scheduled at a time later than a time for introducing substrate into the substrate processing apparatus and makes a plurality of units U operate according to the time chart. Therefore, it is possible to shorten a period from end times Te5 to Te7 at each of which all of steps conducted by a plurality of units U is completed to a end time limit LT. Especially, according to the present embodiment, because end times Te5 to Te7 coincide with an end time limit LT, it is possible to dispense with a period therebetween. Chemical liquids are not supplied to a substrate W during a period from a time when all of steps to be carried out by a plurality of units U is complete to an end time limit LT. Thus by shortening the period, it is possible to shorten a period during which chemical liquids life times are wasted away, thereby permitting effective use of chemical liquids. In other words, since postponing a start time of a chemical liquid results in postponement of a time when a life time of the chemical liquid is exhausted, the similar effect can be achieved as in acquiring longer life time of the chemical liquid. Thereby chemical liquids can be utilized for more substrate processing, permitting reduction of chemical liquid consumption.

Also, according to the present embodiment, the main controller 6 acquires a plurality of production informations to prepare a time chart (the eighth time chart) in which a plurality of substrates W corresponding to a plurality of production informations are continuously processed. Specifically, the main controller 6 integrates a plurality of production informations, preparing a time chart based thereon. And then, the main controller makes a plurality of units U operate according to the time chart. Because a plurality of substrates W corresponding to a plurality of production informations are continuously processed, it is possible to shorten an operating period compared with a case in that a plurality of substrates W are intermittently processed. Stated differently, it is possible to increase non-operating period. Therefore, it is possible to further decrease consumption of electric power.

Also, according to the present embodiment, number of substrate processing by each of processing units MPC is counted by a counter 26 in the main controller 6. The main controller 6 prepares time charts (the ninth and tenth time charts) that averages the numbers of substrate processing by each of the processing units. Thus, when a maintenance part that is to be exchanged according to number of substrate processing is arranged in each of processing unit MPC, it is possible to average numbers of use for each maintenance parts. Thus times for replacement for a plurality of maintenance parts coincide or nearly coincide with each other, which permit the plurality of maintenance parts to be replaced simultaneously. Therefore number of times to halt the substrate processing apparatus 1 to replace maintenance parts can be reduced, permitting improvements on productivity of the substrate processing apparatus 1. Moreover, as each one of maintenance parts is averagely used, replacement of inclusive maintenance parts results in effective uses of the maintenance parts, even when only some of the maintenance parts are required to be replaced.

Also, according to the present embodiment, a sensor 13, 19 for detecting bad condition of the substrate processing apparatus 1 are provided in the substrate processing apparatus 1. These sensor 13, 19 are supplied with electric power on a steady basis, thus it is possible to securely detect bad conditions of the substrate processing apparatus 1. Stated differently, it is possible to decrease consumption of electric power without sacrificing operation for detecting bad conditions.

While the embodiment of the present invention have been described hereinabove, the present invention may be put into practice with various modifications within the scope of the claimed invention without being limited by the descriptions in the aforementioned embodiment.

For example, although in the aforementioned embodiment, a case was explained wherein end times Te5 to Te7 for fifth to seventh time charts coincide with an end time limit LT (See FIG. 8), end times Te5 to Te7 for fifth to seventh time charts may be set at an earlier than end time limit LT.

Furthermore, although in the aforementioned embodiment, a case is explained wherein four processing units MPC are connected to a common chemical liquid supply unit CC, chemical liquid supply unit CC may be provided for each of processing units MPC.

Although the preferred embodiment of the present invention has been described in detail, the embodiment is merely an specific example used to clarify the technical content of the present invention and the present invention should not be understood as being limited to the specific example and the scope of the present invention is limited solely be the appended claims.

The present application corresponds to Japanese Patent Application No. 2011-058263 filed in the Japan Patent Office on Mar. 16, 2011, the entire disclosure of which is incorporated herein by reference.

### REFERENCE NUMERALS AND CHARACTERS LIST

1 substrate processing apparatus
6 main controller (control device)
13 first sensor (sensor)
19 second sensor (sensor)
22 ON/OFF switching device
26 counter
CC chemical liquid supply unit (unit)
CR center robot (unit)
IR indexer robot (unit)
MPC processing unit (unit)
SH shuttle (unit)
W substrate

1. A substrate processing apparatus for processing a substrate comprising:
a plurality of units for carrying out steps for processing the substrate;
a plurality of ON/OFF switching devices, corresponding to the respective units, switching between an ON state in which electric power is supplied to a corresponding unit and an OFF state in which supply of electric power for the unit is halted; and
a control device for acquiring a production information including processing details and an end time limit for a substrate to be introduced into the substrate processing apparatus, preparing a time chart representing an operation scheme for the plurality of units based on the production information in a manner such that all of the steps carried out according to the processing details by the plurality of units are to be completed by the end time limit, and making the plurality of units operate according to the time chart while controlling the plurality of ON/OFF switching device according to the time chart.

2. The substrate processing apparatus according to claim 1, wherein the control device controls the plurality of ON/OFF switching device in a manner such that supply of electric power is halted for at least one of the plurality of the units during a non-operating period that is included in an executable period which spans from a time the substrate is introduced into the substrate processing apparatus to the end time limit.

3. The substrate processing apparatus according to claim 1, wherein the control device controls the plurality of ON/OFF switching devices in a manner such that supply of electric power is halted for at least one of the plurality of units in a non-operating condition during an operating period in which at least one of the plurality of units is operated according to the time chart.

4. The substrate processing apparatus according to claim 1, wherein the plurality of units include a plurality of processing units for processing the substrate and the control device prepares the time chart in a manner such that a number of the processing units to be operated is minimized.

5. The substrate processing apparatus according to claim 1, wherein the plurality of units include a processing unit for processing the substrate and a plurality of chemical liquid supply units for supplying chemical liquid to the processing units and the control device prepares the time chart in a manner such that a number of the chemical liquid supply units to be operated is minimized.

6. The substrate processing apparatus according to claim 1, wherein the plurality of units include a processing unit for processing the substrate and a chemical liquid supply unit for supplying chemical liquid to the processing unit, and the control device prepares the time chart in a manner such that a operation start time for the chemical liquid supply unit is scheduled at a time later than a time when the substrate is introduced into the substrate processing apparatus.

7. The substrate processing apparatus according to claim 1, wherein the control device acquires a plurality of product information to prepare a time chart by which a plurality of substrates corresponding to the plurality of production informations are sequentially processed.

8. The substrate processing apparatus according to claim 1, wherein the plurality of units include a plurality of processing units for processing substrate, and the control device includes a counter for counting a number of substrate processing by each of the processing units and prepares a time chart in a manner such that each of the numbers of substrate processing by each of the processing units takes an averaged number.

9. The substrate processing apparatus according to claim 1, further comprising a sensor, detecting malfunction of the substrate processing apparatus and being supplied with electric power on a steady basis.

10. A power source management method for managing electric power supply for substrate processing apparatus, comprising:
an acquiring step of acquiring a production information including processing details and an end time limit for a substrate;
a preparing step of preparing a time chart representing an operation scheme for the plurality of units according to the production information in a manner such that all of the steps carried out according to the processing details by the plurality of units is to be completed by the end time limit;
a making step of making the plurality of units operate according to the time chart by the control device; and
a controlling step of controlling a plurality of ON/OFF switching devices, corresponding to the respective units, switching between an ON state in which electric power is supplied to a corresponding unit and an OFF state in which electric power is halted, according to the time chart.
